(19) United States
(12) Patent Application Publication
(10) Pub. No.: US 2006/0039241 A1
(43) Pub. Date: Feb. 23, 2006

(54) Medical timing apparatus and method for use during pregnancy

(76) Inventors: Frank P. Forbath, Costa Mesa, CA (US); Cesar A. Capellini, Newport Beach, CA (US); Bahram R. Esfahani, Costa Mesa, CA (US); Victor E. Penan, Corona del Mar, CA (US)

Correspondence Address: GRAY, PLANT, MOOTY, MOOTY & BENNETT, P.A., P.O. BOX 2906, MINNEAPOLIS, MN, 55402-0906, US

(21) Appl. No.: 11/204,511

(22) Filed: Aug. 16, 2005

Related U.S. Application Data
(60) Provisional application No. 60/602,567, filed on Aug. 17, 2004.
(60) Provisional application No. 60/684,620, filed on May 24, 2005.

(51) Int. Cl. G04F 8/00; G04F 10/00

(52) U.S. Cl. 368/110; 702/178

(57) ABSTRACT

A childbirth labor timing, practicing and alerting apparatus and method. The apparatus includes a portable device with a housing having a display screen and one or more input controls to input the start and end of successive contractions. The device includes a processor and a memory for receipt, storage and display of contraction duration, interval and elapsed time information; for the storage of practice information; for setting and displaying time of day; for receipt and storage of alert data; and for data transmission with a remote unit. The apparatus can include a remote alert data entry unit located at the office of a doctor or other medical facility. Alert data can be entered into the portable device from the remote alert data entry unit. Communication between the remote alert data entry unit and the portable device can be wired or wireless.

### CROSS REFERENCE TO A RELATED APPLICATION

This application claims the benefit of provisional patent application Ser. No. 60/602,567 filed Aug. 17, 2004 and provisional patent application Ser. No. 60/684,620 filed May 24, 2005.

### BACKGROUND OF THE INVENTION

The doctor of an expectant mother-to-be generally advises the expectant mother/couple to monitor labor contractions and to contact the doctor, medical staff or hospital when certain signs are indicative of impending birth. Such critical alert signs may include labor contraction duration times of at least so many seconds, intervals between successive contractions of less than so many minutes, and possibly a count of at least a certain number of each type of contraction measurements. Armed with this alert information the expectant mother/couple is better able to judge when medical advice should be solicited.

Prior art medical timing devices time contractions during a pregnancy based upon input by the expectant mother, and calculate and display the time interval between contractions and the contraction duration in order to give pertinent information to the expectant mother. Prior art devices and methods also contemplate storing data sets of contraction parameters for the purpose of alerting the expectant mother of approaching childbirth. Such devices also can be programmed with practice routines. See U.S. Pat. No. 6,785,193 to Forbath.

### SUMMARY OF THE INVENTION

The invention pertains to a handheld childbirth labor timing, practicing and alerting apparatus and method generally of the type disclosed in U.S. Pat. No. 6,785,193 to Forbath issued Aug. 31, 2004 and incorporated herein by reference. The device includes a portable housing with a display screen and one or more input controls to input the start and end of successive contractions. The device includes a processor and a memory for receipt, storage and display of contraction information; for the storage of practice information; for setting and displaying time of day; for receipt and storage of alert data; and for data transmission with a remote unit. The device can execute methods for the simple timing of the durations of and intervals between actual childbirth contractions as well as elapsed time since the most recent labor contraction; for practicing selected routines of such contractions in preparing for childbirth; and for receiving and storing alert data (M.D. instructions) in the form of a set of contraction parameters that when matched with a set of actual contraction events presents an alerting signal to a user so as to timely seek medical advice.

In a labor contraction timing mode the apparatus records the user inputted start and end time of successive contractions. The device calculates and stores values of the interval between the start of each contraction and the start of the next contraction as well as the duration of the contraction. The stored or calculated contraction information can be displayed simultaneously or sequentially. The device can display the elapsed time since the start of the most recent contraction.

In an alert mode the device provides an audio and/or visual alert signal when indications are that the user is entering the possible onset of childbearing, i.e., when a set of actual contraction events which are entered into the memory of the apparatus during labor matches prerecorded alert data. Alert data as used herein means a set of hypothetical contraction events the occurrence of which the medical staff has determined to be indicative of possible childbirth. Such a prerecorded set of contraction events may be, for example, when contraction durations are at least 60 seconds, or when there are four or more contractions of 50 seconds duration, or when contraction intervals are seven minutes apart, etc. Such a request may consist of the conjunction of two or more timing sequence conditions or may be expressed in the alternative. The alert data can be preloaded or downloaded from an external alert data entry unit. The downloading can be either wire line or wireless.

In the present text the term “user” means the woman preparing for childbirth, her spouse, her birthing coach or other individuals performing similar roles and who actually manipulate and interpret results in the use of the invention. The term “contraction duration” means the amount of time from the start to the end of an individual labor contraction. The term “contraction interval” means the amount of time between the start of two successive contractions, although an alternative interpretation may be substituted.

The device can be preloaded with practice information accessible in a practice mode and usable by the expectant mother or couple for practice as described in the aforementioned U.S. Pat. No. 6,785,193. Such practice may be suggested by the physician, nurse, childbirth educator or the like.

### BRIEF DESCRIPTION OF THE DRAWINGS

FIG. 1 is a front elevational view of a medical timing apparatus according to an embodiment of the invention;

FIG. 2 is a block diagram of the components of the apparatus of FIG. 1;

FIG. 3 is a schematic view of a medical timing apparatus including a hand held device and a medical office located alert data entry unit;

FIG. 4 is a schematic view of a medical timing apparatus including a hand held device and another form of medical office located alert data entry unit;

FIG. 5 is an enlarged view of the alert data entry unit shown in FIG. 4; and

FIG. 6 shows alternative host devices in which the portable device of the medical timing apparatus can be installed.

### DESCRIPTION OF A PREFERRED EMBODIMENT

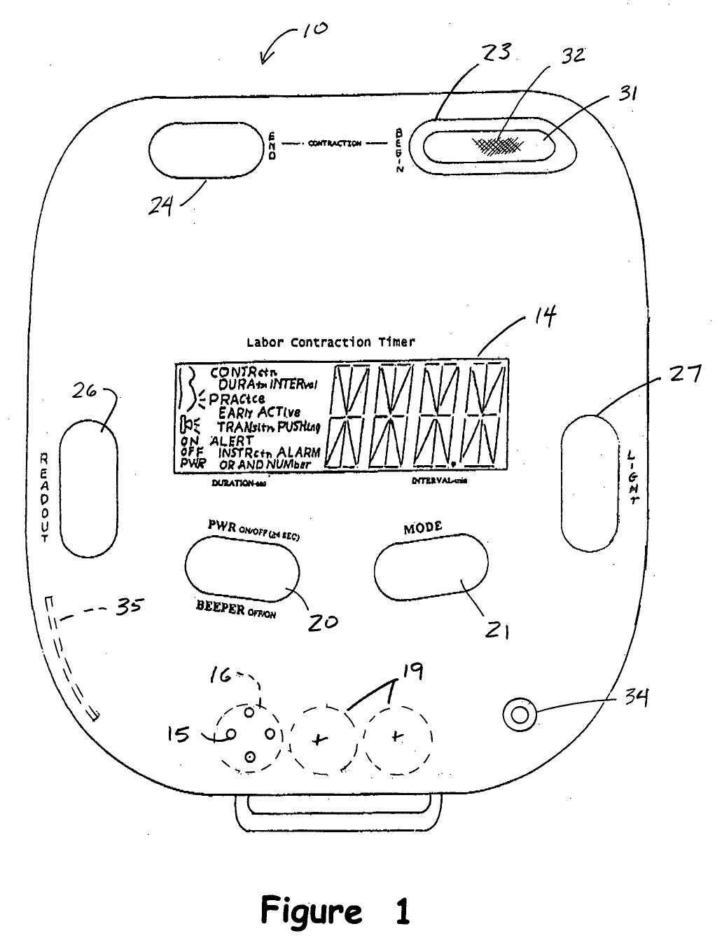

A medical timing apparatus according to one embodiment of the invention includes a portable device 10 shown in FIG. 1 having a housing 11 encasing various components. Housing 11 has a size and shape to be conveniently hand held. Housing 11 could have other suitable configurations as might render it suitable for carrying like a pendant, wearing on the wrist like a watch or the like. Also the functions described herein could be incorporated into the existing packaging of a cell phone, a PDA or other portable device.

Device 10 has a visual display 14 and a sound port 15 covering an audio device 16 such as a beeper, buzzer or other suitable audio signal device including a speech synthesizer. A backlight switch 27 enables the user to backlight the screen 14 under low ambient light conditions. Power to the device 10 is provided by one or more batteries 19 connected to the various power requiring components by an on/off switch 20. Switch 20 can also control the on/off function of the audio device 16.

A data port 34 is provided for wired receipt of labor contraction data from a remote unit. Alternatively an antenna 35 is provided as a portal for wireless communication of contraction data with a remote unit.

A button switch 21 controls mode and sub-mode selection. In the embodiment discussed there are four modes. These are the labor contraction timing mode (LCT); a practice mode (PRAC); and alert mode (ALERT); and a time of day mode (TOD). All modes except LCT have sub-modes. Prior to selecting and activating any mode, the modes can be sequentially identified by successively briefly depressing the Mode switch 21. A mode is selected after depressing the Mode switch for one second. Alternatively a mode is automatically selected after being identified continuously for three seconds.

In the LCT mode the user inputs the beginning and end of each labor contraction of a series of labor contractions. User input switches in the form of button switches are provided so that the user of the device can mark the expectant mother sensed beginning of a labor contraction and the end of the contraction. The begin and end functions can be incorporated into a single button or, as shown, employ separate button switches. The device 10 has a “begin” button 23 and an “end” button 24 spaced from the begin button 23. An expectant mother will frequently be distracted by various other things when sensing a forthcoming contraction or be in a dimly lighted environment and doesn't need confusion engendered by having to remember which button to push. Accordingly the begin and end buttons can advantageously be differentiated by feel. The buttons can be differentiated by shape, size, height, surface irregularity such as texture, or the like. As shown the begin button is longer than the end button, has a raised rib 31 with a knurled surface texture 32. The end button has a smooth uninterrupted surface clearly differentiating it from the begin button.

In use of the device 10 in LCT mode, the user, typically the expectant mother, selects the LCT mode with switch 21. However, in an emergency, e.g. while driving, in the middle of the night, etc., the user can immediately select the LCT mode by pushing the Begin button, 23 for one second, whether power has been off, in the middle of PRAC mode or in TOD mode. In the LCT mode, the user marks in time the beginning of a first labor contraction of a contraction series by pressing the begin button 23. The end of each contraction of the series is marked in time by pressing the end button 24. This is repeated through successive contractions for the contraction series. The device times and records the mother-sensed duration of each contraction and calculates the interval between the start of each contraction and the start of the next contraction. The data are stored in memory and can be read out as desired typically but not necessarily with the last recorded duration and interval displayed first.

A readout button 26 enables the user to ratchet through successive readout recordings of durations and intervals starting with the most recent. The readout of previous contraction data during LCT can be initiated at any time other than during a current contraction. Readouts begin with the most recent contraction and then follow in time sequence going back. The user depresses the readout button 26 for a minimum of ¼ second for each successive readout selected. Appropriate words, abbreviations or icons can be chosen for indicating the display of a duration or an interval (see FIG. 1).

Upon LCT mode initiation, the unit signals by the icon CONTRctn as shown on the display screen 14 in FIG. 1. The icon is displayed, along with a flashing dot, for ⅛^{th} second once a second. When the contraction begin button 23 is pushed for ½ second or more, the beeper sounds for ⅛^{th} second, the CONTRctn icon is removed and a DURAtn icon (see FIG. 1) is continuously displayed along with the time in seconds until the end button 24 is pressed. Upon contraction ending as indicated by pressing the end button 24 for at least ½ second, the duration time is displayed for two seconds and then reverts to idle condition. That time display is preceded by DUR-/A-/TION for approximately ¼ second immediately before the displayed time. Duration time is stored. A duration time of less than a predefined minimum, for example 20 seconds, is displayed but not stored. The display can appear as follows:
DUR-/A-/TION//13//NOT//IN//MEM-/ORY//<20//SEC

Duration beyond 180 seconds is stored only as LONG. The interval time is stored also but interval time beyond a maximum, for example 20 minutes, is simply stored as LONG.

During labor contractions, often the contractions are intermittent. They may frequently slow down after a period of short intervals between contractions then speed up. The elapsed time since the commencement of the most recent contraction extending beyond the ending of that contraction is useful information to the user who will likely be otherwise too distracted to keep separate track of this information. Accordingly, device 10 tracks the elapsed time since the start of the most recent contraction. Elapsed time in LCT mode is defined as the time from the start of the most recent contraction to the present time, given in minutes. The elapsed time is briefly displayed periodically and calculated the same as though it were a duration from the start of the most recent contraction. The elapsed time display can commence after a designated time interval from the most recent contraction, for example, two minutes.

In the use of the device in the practice mode, the user selects PRAC using the mode button 21, then selects a desired sub-mode. The practice mode can function as disclosed in U.S. Pat. No. 6,785,193. A non-volatile portion of memory 40 has factory installed practice instruction sets. Such instruction sets can be included in sub-modes of early labor, active labor, transition labor, and pushing labor instruction sets. The instruction set options can be displayed on screen 14. The user selects an instruction set. The processor is programmed to use a random number generator to generate variations of contraction interval and duration data and display the pertinent calculations on the screen 14 as well as giving audio information through audio device 16. The user participates according to instructions such as by performing desired breathing and exercising actions.

The alert mode has an alert sub-mode and a signal sub-mode. The doctor of the expectant mother generally advises the mother to monitor her labor contractions and to contact him/her, the medical staff or hospital when certain signs that might indicate impending birth appear to her. A stressed user may have difficulty recalling and focusing upon the directions of the doctor as to when to seek medical advice when certain specified contraction parameters are met. The alert mode permits the recording of the directions of the mother's doctor as to when the medical staff should be contacted or when she should go to the hospital for likely delivery based in part on the timing of her contractions. The directions of the doctor may be simple, such as to call when the contractions are as long as 60 seconds, or to call when the contractions come as frequently as five minutes apart. On the other hand the directions may be more complex, for example, to call when there are four or more successive contractions of a least 50 seconds in length and the contraction interval is less than six minutes. Such directions can be entered into the device 10 to later automatically alert the user when communication with the doctor is indicated. In the alert mode when the signal sub-mode is selected by depressing the mode selection button 21, the device compares the entered alert data with the actual calculated values derived from mother in-labor inputted information. When there is a match an alert condition is signaled. This may be visually on the screen or an audio signal through the sound port 15 or both. As an example upon Signal initiation, the beeper can signal at four beeps per second for one second on, then one second off, alternately for the first four seconds. The beeper can be turned off earlier with switch 20. The display can flash CALL//MD along with an icon ALARm for a total of ten seconds. The Alarm sub-mode can also turn on the back light for the ten second interval. In addition there may be an alert signal remotely transmitted to a remote medical unit.

The alert data can be entered into the device 10 in accordance with the teaching of U.S. Pat. No. 6,785,193. Alternatively alert data can be entered through a medical office located alert data entry unit as described below.

Whenever LCT, PRAC or ALERT are not in use, TOD automatically is presented. Sub-modes of TOD are for separately setting the time in hours and minutes. When in LCT or PRAC in between contractions, TOD can be displayed every few seconds.

The display and beeping accompanying the various control inputs, as well as the display and beeping resulting from processor outputs, also can be sent in the form of synthesized voice.

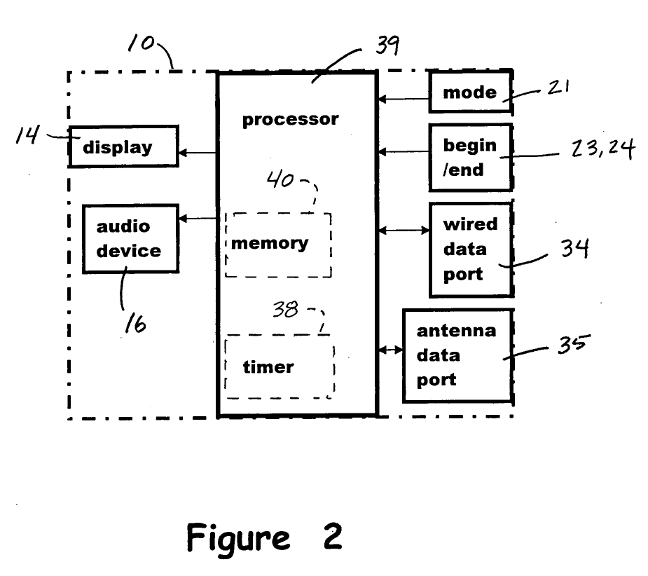

The block diagram of FIG. 2 schematically depicts the components of the device 10. The input controls 23, 24 are connected to a timing device 38 incorporated into a processor 39. Timing circuit of the timing device records the user inputted begin of a labor contraction as well as the user inputted end of the labor contraction. The timing device also tracks the elapsed time since the commencement of the most recent contraction. A memory device 40 combines volatile and non-volatile memory types for storing input and output information as well as factory installed practice patterns. Data port 34 and antenna 35 input to processor 39 although the device 10 will typically have one or the other, if either. The processor controls the display 14 and audio output device 16.

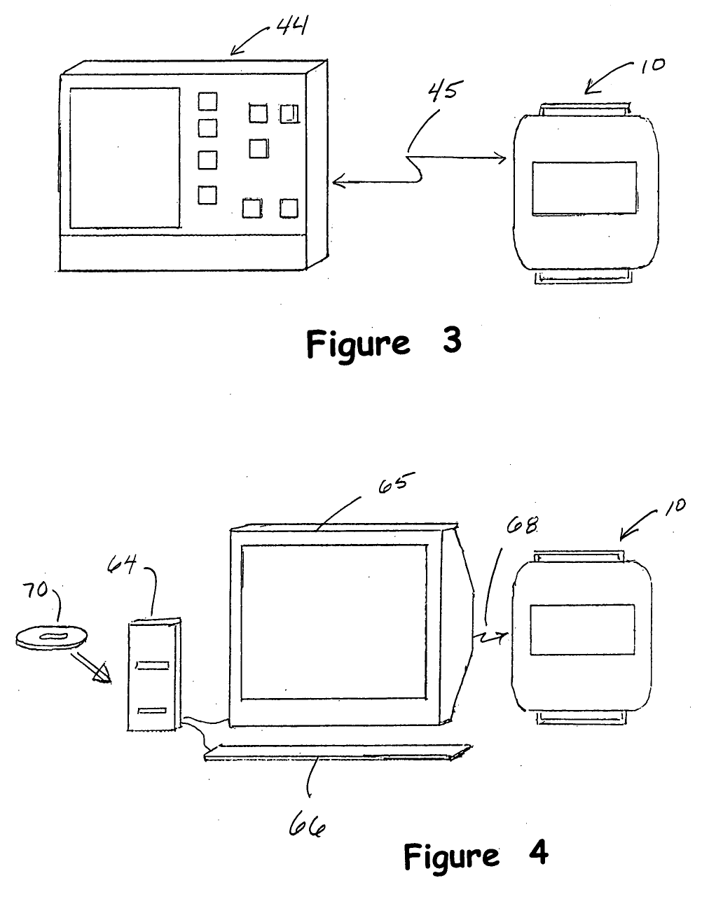

The transfer of the doctor's written or verbal instructions pertaining to the alert data into the device 10 can be difficult for some individuals and is, in any event, subject to error upon input. Accordingly there is provided a remote programming capability for inputting and storing an alert data for device 10. Referring to FIG. 3, there is shown a remote alert data transfer unit 44 in conjunction with a portable device 10. The remote alert data transfer unit 44 is connectable to the portable device 10 by a data transmission link 45 in to enable the transmission of an alert data from the data transfer unit 44 to the portable device 10. The data transmission link can be any desired data link between two devices. The data transmission like can be wired or wireless. The link can be as simple as a cable connection between the data transfer unit 44 and the portable device 10 with the devices located in side-by-side relationship. The data transmission link can be over a local area network or a wide area network. The data transmission link can be wireless such as via Blue Tooth™, ZigBee™ or a similar protocol.

FIG. 4 shows an alert data transfer unit in the form of a personal computer 64 connected to a monitor 65 and having a keyboard 66. Computer 64 has a data transmission connection 68 to the portable device 10. Software can be carried on media 70 and loaded into computer 64 or similar standard office type computer to perform the functions described with respect to the alert data transfer unit shown in FIG. 3.

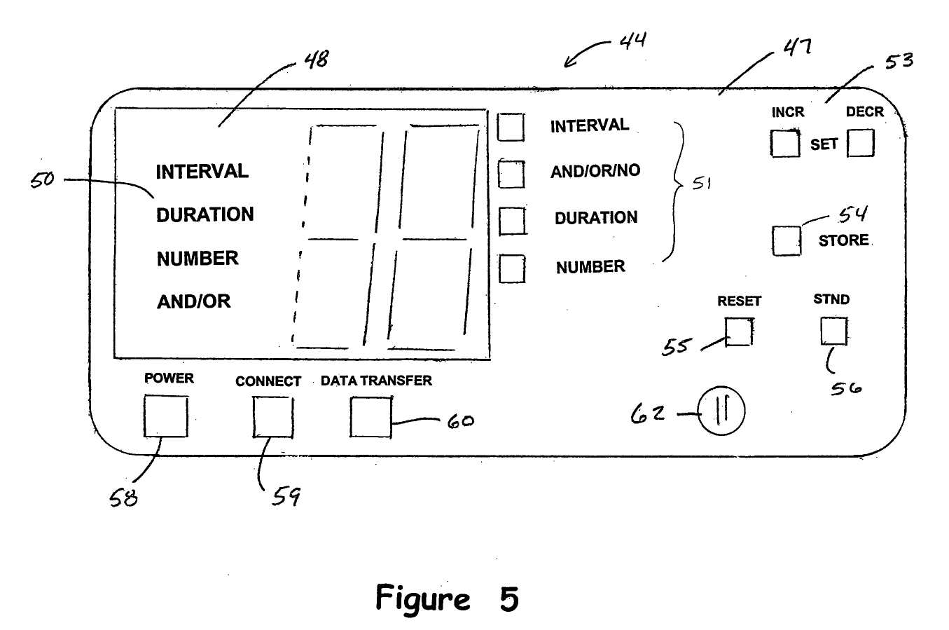

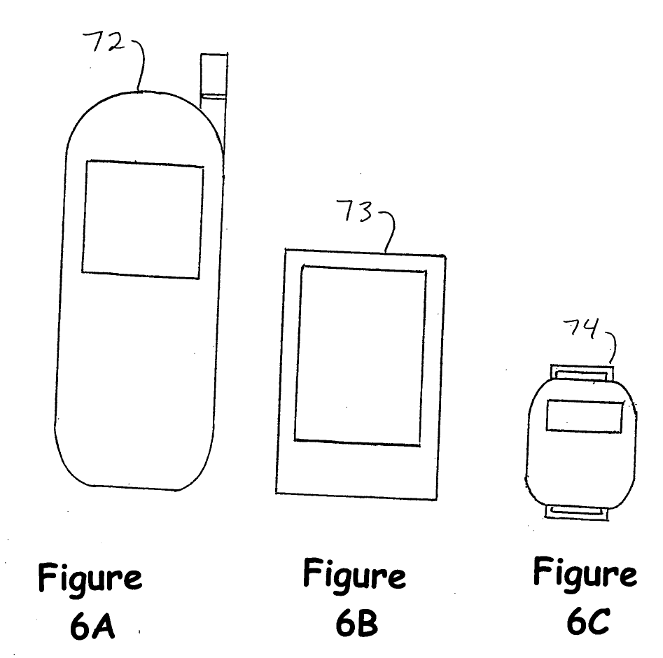

A particular example of an alert data transfer unit 44 of FIG. 3 is more particularly shown in FIG. 5. Alert data transfer unit 44 includes a housing 47 with a display 48 which can be a liquid crystal display or other display device. The display 48 has parameter indicators 50 proximate a digital display to indicate a particular available input parameter being displayed such as contraction interval, duration, number and the Boolean AND/OR operators. The doctor may specify that he/she or the medical staff be contacted when an interval(s) comes down to or less than a certain time, as determined by the expectant mother. The doctor may specify that contact be made when the duration of a contraction(s) lasts at least as long as a certain time. The number of intervals refers to the minimum number of intervals of successive contractions that meet the doctor specified interval conditions. The number of durations refers to the minimum number of durations of successive contractions that meet the doctor's duration conditions. The AND/OR refer to the Boolean operators that are used as connectors to permit a joining yet limiting of the doctor's requirements.

The parameter indicator 50 corresponding to the selected parameter can be highlighted, bolded, flashing or the like to indicate the active status. Parameter entry keys 51 are provided for selection of the parameter to be entered. A parameter numerical value can be changed using the INCR/DECR keys 53. A power button 58 turns power on and off. A display lit button 59 provides for and confirms the connection of the alert data transfer unit to the portable device. The data transfer key 60 initiates alert data transfer to the portable device 10. The store key 54 allows storage in memory of a particular alert data.

The data transfer unit can have normal or default settings of the contraction parameters. A reset button 55 will reset the device to the default settings. A standard reset button 56 permits a change in the default settings. A lock 62 can preclude unauthorized use of the data transfer unit.

By way of example, a hypothetical doctor instruction can be that the doctor should be called when the expectant mother experiences four or more contractions of 60 seconds or more in length or has at least two contractions coming as fast as five minutes apart. This can be expressed as:
(duration ≧60 seconds AND number ≧4) OR (interval ≦5 minutes AND number ≧2)
   This alert data is entered by a member of the responsible medical staff using the alert parameter entry keys 51. Depressing first the DURATION key, the programmer views the displayed default value and, if other than “60” is displayed, adjusts the value to 60 using the INCR/DECR keys 53. During this period the DURATION indicator 50 on display is flashing indicating that it is active. Upon reaching the target value, the programmer presses the NUMBER key adjusts the value to 4. The programmer next presses the AND/OR/NO key and proceeds in like fashion until finished.

Before data transfer the operator confirms that the alert data transfer unit 44 is connected to the device 10. This can be indicated by the CONNECT key being lit. Next the operator pushed the DATA TRANSFER key to initiate transfer of the alert data to the portable device.

FIG. 6A shows a cell phone 72 that hosts the device 10 inclusive of the functions of device 10. The cell phone 72 can contain software further modified to be able to transfer ongoing LCT data to medical staff upon completion of a dial-up to the medical office. Upon response, data can be directed to a computer or fax machine. Also the data can be relayed to a modified alert data entry unit 44. In addition the cell phone can receive alert data upon the inclusion of a telephone with the medical office located alert data transfer unit.

In like manner the functions of device 10 can be incorporated into a personal digital assistant (PDA) 73 (FIG. 6B) or a sophisticated digital watch 74 (FIG. 6C). The host device can have minor hardware modifications as might be necessary or desirable.

The embodiments of the invention in which an exclusive property or privilege is claimed are defined as follows:

1. A medical timing device for use during pregnancy, comprising:
a portable housing;
a processor located in the housing and having a memory and a timing device;
a display device connected to the processor;
a begin input device connected to the processor for a user input marking in time the commencement of a labor contraction that is one of a series of successive labor contractions;
an end input device connected to the processor for a user input marking in time the end of a labor contraction that is one of a series of successive labor contractions;
wherein in a labor contraction timing mode said processor calculates and stores the duration and interval for each contraction of a series of successive contractions and tracks the elapsed time in seconds and minutes since the most recent user begin input; and
wherein the duration and interval information can be selectively displayed on the display device and said elapsed time can be selectively displayed on the display device.

2. The medical timing device of claim 1 wherein:
said begin input device is a first button and said end input device is a second button, said first and second buttons being differentiated by feel.

3. The medical timing device of claim 2 wherein:
one of said buttons is larger than the other button.

4. The medical timing device of claim 2 wherein:
the buttons are shaped differently.

5. The medical timing device of claim 2 wherein:
one of said buttons has surface irregularities.

6. The medical timing device of claim 1 including:
a data port connected to the processor for receipt of data from a remote data entry unit.

7. The medical timing device of claim 1 including:
an antenna connected to the processor for wireless receipt of data from a remote data entry unit.

8. The medical timing device of claim 1 wherein:
said processor has a time of day mode and a practice mode and an alert mode;
said time of day mode permitting setting and selectively displaying time of day;
said practice mode including said memory having stored practice routines for practicing childbirth events;
said memory having stored medical instructions as to when to seek medical advice when interval and duration information calculated from contractions of a series of successive contractions matches the stored medical instructions;
said processor having an alert mode for comparing the medical instructions with stored interval and contraction information to seek a match and send an alert to the display device; and
a mode control to enable a user to move between modes.

9. The medical timing device of claim 8 including:
a readout control to said display device.

10. The medical timing device of claim 8 including:
an audio device connected to the processor.

11. The medical timing device of claim 8 wherein:
the device has cell phone components.

12. The medical timing device of claim 8 wherein:
the device has personal digital assistant components.

13. The medical timing device of claim 8 wherein:
the device has digital watch components.

14. A labor contraction timing method comprising the steps of:
providing a portable device having a visible display, labor contraction begin and end input controls, and a processor with a timing device and a memory device;
marking in time with the begin input control the beginning of each contraction of a series of contractions;
marking in time with the end input control the end of each contraction of a series of contractions;
calculating the duration of each contraction and the interval between adjacent contractions for the series of contractions;
tracking the elapsed time since the marking of the beginning of the most recent contraction;
displaying the duration and contraction information; and
displaying the elapsed time information.

15. The labor contraction timing method of claim 14 including the step of:
providing alert data stored in the memory;
comparing the duration and contraction information with the alert data and sending an alert signal when there is a match.

16. The labor contraction timing method of claim 15 including the step of:
entering alert data into the memory from a remote alert data entry unit.

17. A medical timing apparatus for use during pregnancy, comprising:
a medical timing device having a portable housing;
a processor located in the housing and having a memory and a timing device;
a display device connected to the processor;
a begin input device connected to the processor for a user input marking in time the commencement of a labor contraction that is one of a series of successive labor contractions;
an end input device connected to the processor for a user input marking in time the end of a labor contraction that is one of a series of successive labor contractions;
said processor having a labor contraction timing mode wherein said processor calculates and stores the duration and interval for each contraction of a series of successive contractions and tracks the elapsed time in seconds and minutes since the most recent user begin input;
wherein in the labor contraction timing mode the duration and interval information can be selectively displayed on the display device and said elapsed time can be selectively displayed on the display device;
said memory having stored alert data in terms of medical instructions as to when to seek medical advice when interval and duration information calculated from contractions of a series of successive contractions matches the stored alert data;
said processor having an alert mode for comparing the alert data with stored interval and contraction information to seek a match and send an alert to the display device;
a mode control to enable a user to move between modes;
a remote alert data entry unit for entry of alert data into the portable device memory; and
a data transmission link between the portable device and the remote alert data entry unit.

18. The medical timing apparatus for use during pregnancy of claim 17 wherein:
the data transmission link is wireless.

19. The medical timing apparatus for use during pregnancy of claim 17 wherein:
the data transmission link is wired.

20. The medical timing apparatus for use during pregnancy of claim 17 wherein:
the alert data entry unit can be programmed with alert data.
